(19) United States
(12) Patent Application Publication
(10) Pub. No.: US 2007/0262070 A1
(43) Pub. Date: Nov. 15, 2007

(54) Oven with movable element unit

(76) Inventor: Wen-Ching Lee, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/433,694

(22) Filed: May 15, 2006

(51) Int. Cl. A21B 1/00

(52) U.S. Cl. 219/404

(57) ABSTRACT

An oven includes a body and two support rails are located on two opposite insides of the body so as to support grids thereon. A movable element unit is located in the body and includes at least one element which can be moved in the body by the user so that the space can be used efficiently and the food is evenly cooked.

### BACKGROUND OF THE INVENTION

(1) Field of the Invention

The present invention relates to an oven having a movable element unit which is controlled by the user so as to efficiently use the space in the oven.

(2) Description of the Prior Art

A conventional oven generally includes rails on two insides of the oven and a top element and a lower element are located in the space. Food in a baking tray is put on a rack which is supported across the rails, and the top and lower elements generate high temperature to cook the food. It is noted that the top and lower elements are fixed and so as the food. Therefore, only limited space is used to arrange the trays and the food cannot be cooked evenly.

The present invention intends to provide an oven that has a movable element unit which is moved in a pre-set way so as to cook the food at a close distance and this shortens the time required to cook the food.

### SUMMARY OF THE INVENTION

The present invention relates to an oven which comprises a body with a door pivotably connected to a front end thereof and a control panel is connected to the front end of the body. Two support rails are located on two opposite insides of the body and a movable element unit is located in the body. A tray unit is positioned in the body and is driven by a motor unit so that food on the tray unit can be rotated.

The primary object of the present invention is to provide an oven that has a movable element unit and a rotatable tray unit. The element unit can be moved toward the food and the tray unit allows the food to be rotated in the oven.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the oven of the present invention;

FIG. 2 shows a cross sectional view of the body of the oven and the element unit;

FIG. 3 shows another embodiment of the element unit;

FIG. 4 shows a cross sectional view of the element unit in FIG. 3;

FIG. 5 is a cross sectional view of another embodiment of the element unit;

FIG. 5A shows the element is connected with a motor;

FIG. 6 shows the body of the oven and the knob on outside of the body;

FIG. 7 shows yet another embodiment of the element unit;

FIG. 7A shows the positioning member engaged with rack in FIG. 7;

FIG. 8 is an exploded view to show the tray unit of the oven;

FIG. 9 shows another embodiment of the tray unit of the oven;

FIG. 9A shows the worm gear is engaged with the worm rod of the tray unit in FIG. 9, and

FIG. 10 shows the gear set of the motor unit of the oven.

### DETAILED DESCRIPTION OF THE PREFERRED EMBODIMENT

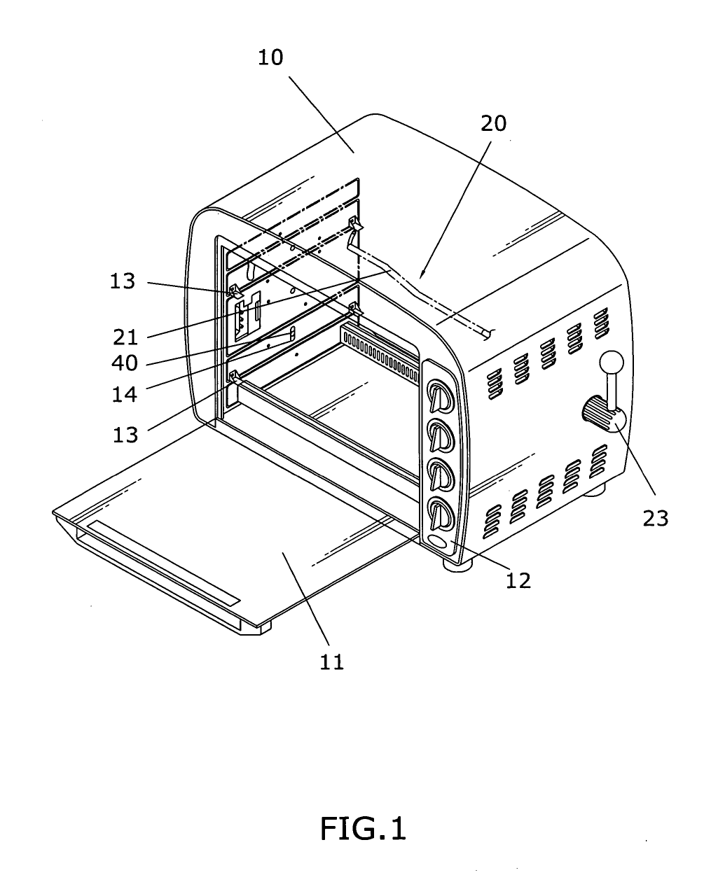

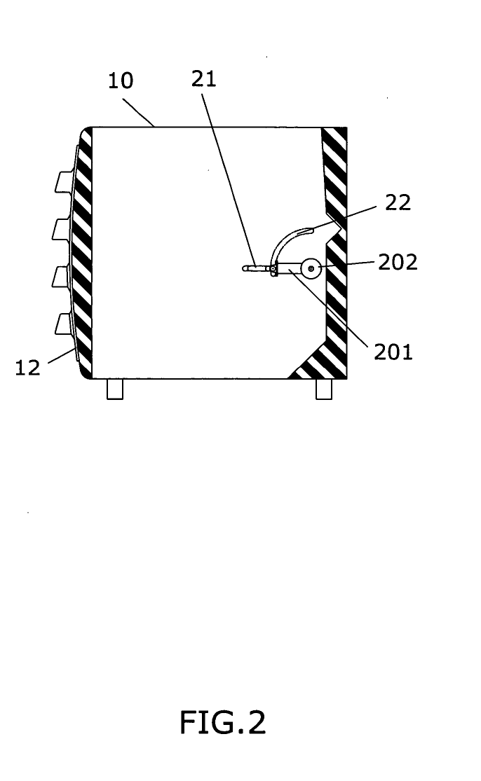

Referring to FIGS. 1 and 2, the oven of the present invention comprises a body 10 with a door 11 pivotably connected to a front end thereof and a control panel 12 is connected to the front end of the body 10. Two support rails 13 are located on two opposite insides of the body 10 and a recess 14 is defined in an inside of the body 10. A motor unit 40 is received in the wall of the body 10.

A movable element unit 20 is located in the body 10 and includes an element 21. A first end of a connection rod 201 is connected to the element 21 and a second end of the connection rod 201 has a connection end 202 with which an operation handle 23. An operation handle 23 is located outside of the body 10 and is connected to the connection end 202. One of the two insides of the body 10 has a slot 22 and a part of the connection rod 201 is movably engaged with the slot 22. The element 21 can be moved when the user rotates the handle 23 to guide the part of the connection rod 201 along the slot 22 which can be a curved slot or a straight slot.

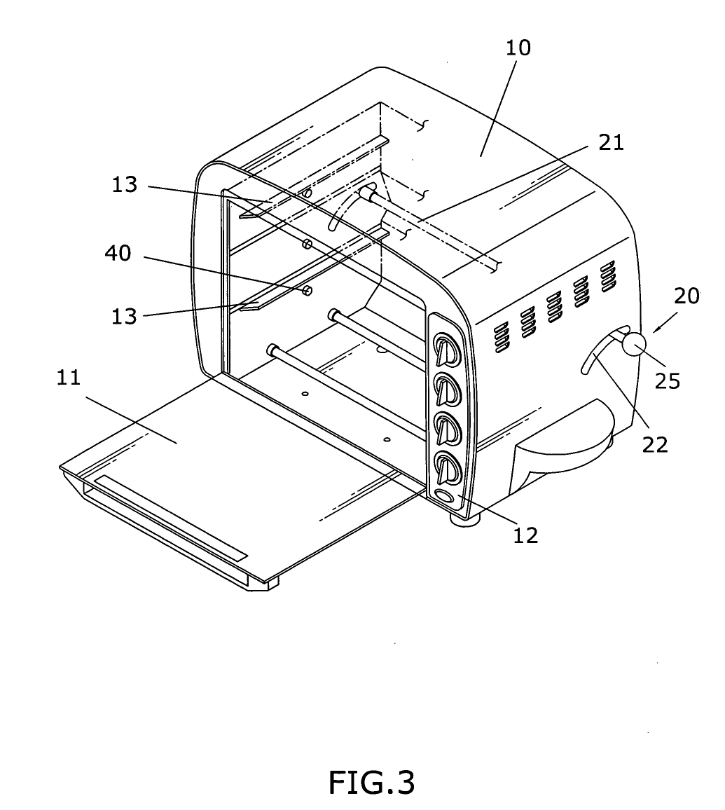

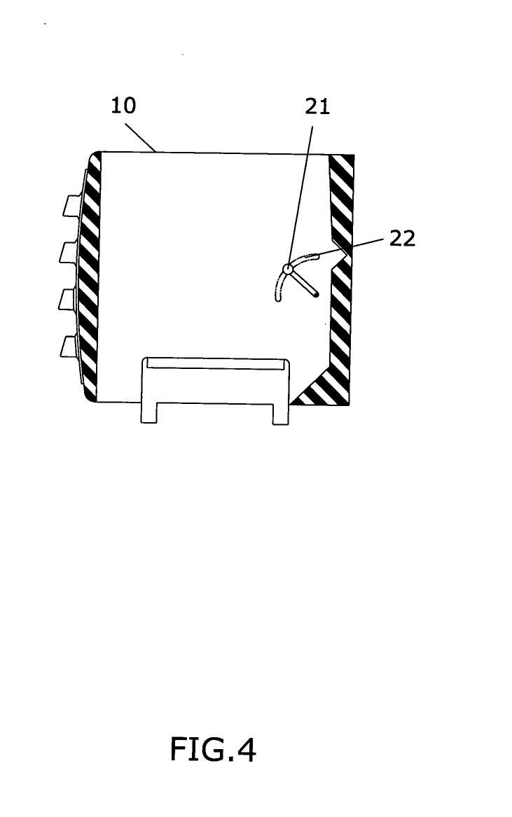

FIGS. 3 and 4 show another embodiment of the present invention, wherein the element unit 20 includes an element 21 and a first end of a connection rod 201 is connected to the element 21. A lever 25 is connected to a second end of the connection rod 201 and located outside of the body 10. One of the two insides of the body 10 has a slot 22 defined therethrough and the lever 25 movably extends through the slot 22 which can also be a curved slot or a straight slot.

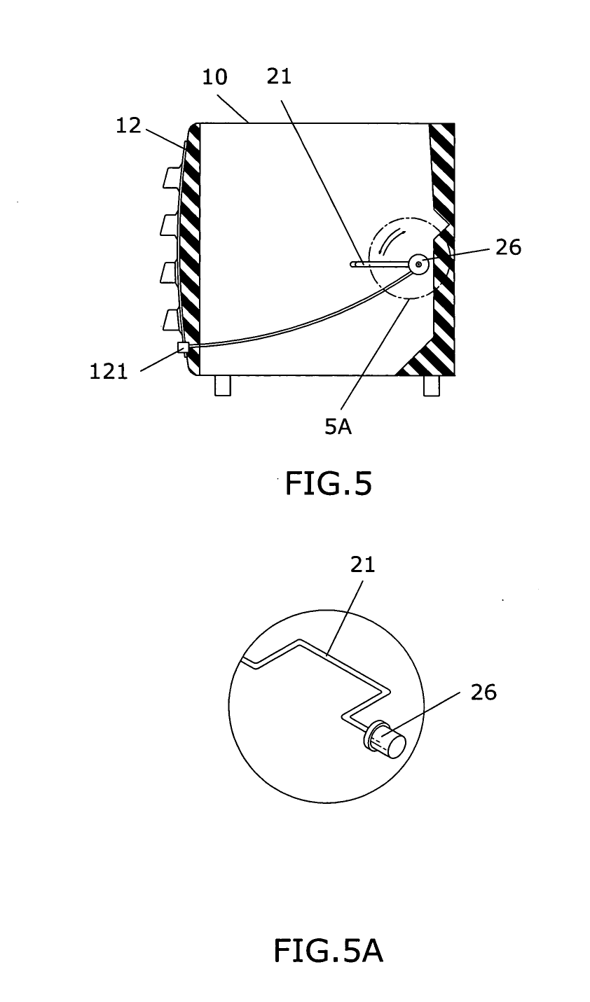

The movement of the element 21 can be operated electrically, referring to FIGS. 5 and 5A, the element 21 is connected with a motor 26 which is controlled by a control button 121 on the control panel 12, the motor 26 is activated by pushing the control button 121 and the element 21 moves in the body 10.

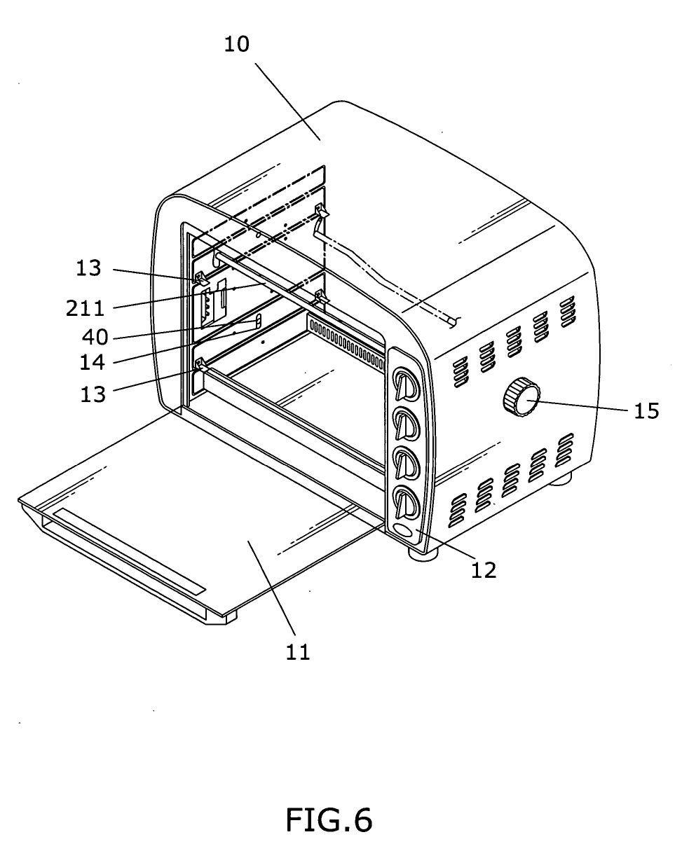

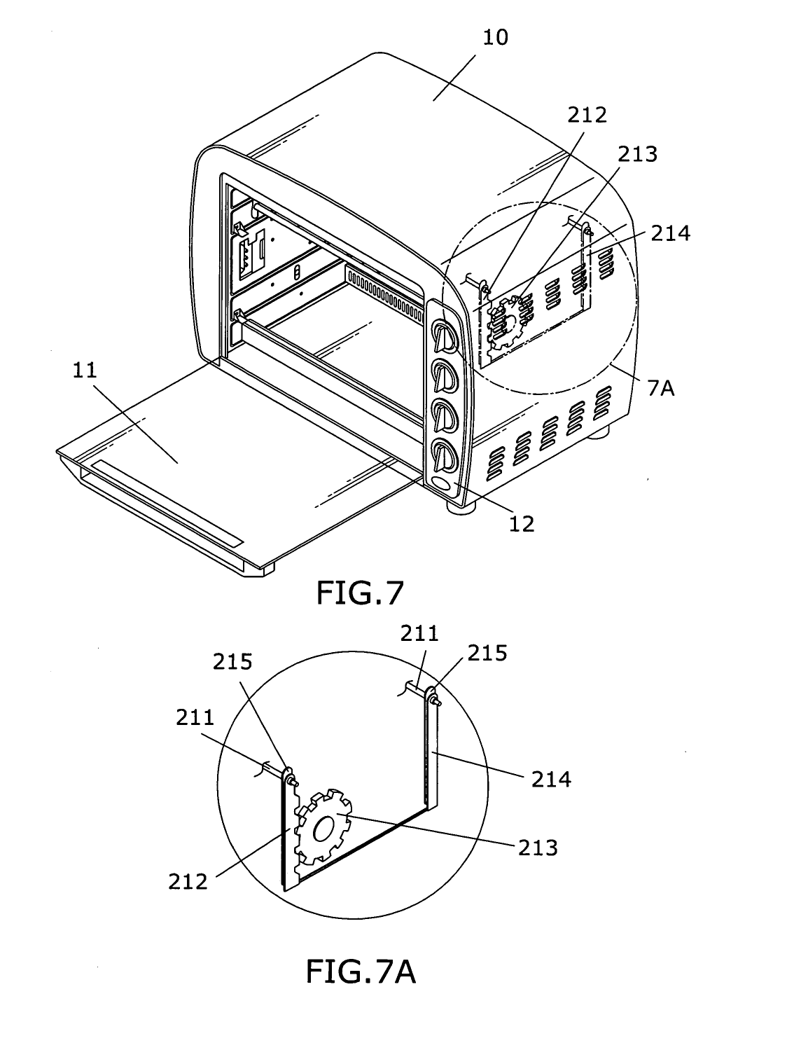

Referring to FIGS. 6, 7 and 7A, yet another embodiment is disclosed, wherein the element unit 20 includes a knob 15 on outside of the body 10, and a gear 213 located in the body 10 and connected with the knob 15. A rack 212 is engaged with the gear 213. A positioning member 214 connected with the element 21 and fixed to the rack 212. The element 211 is connected to the positioning member 214 and can be movably engaged with a slot 215 defined in the body 10. When the user rotates the knob 15, the gear 213 is rotated and the rack 212 is moved linearly such that the positioning member 214 together with the element 211 are moved.

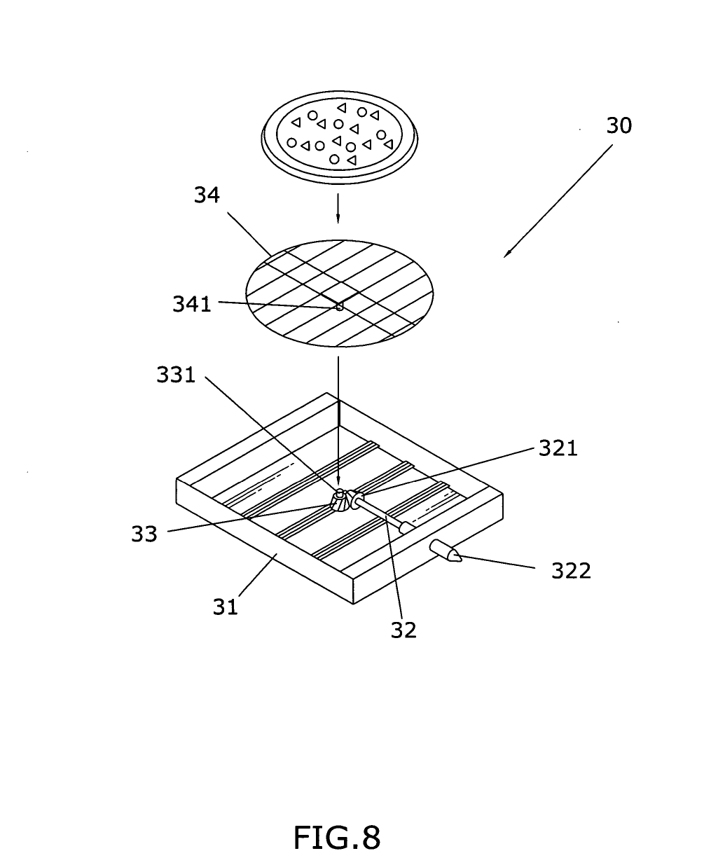

Referring to FIG. 8, a tray unit 30 is used in the oven and food can be put thereon. The tray unit 30 includes a flat tray 31 and a rod 32 extends through an end of the flat tray 31 so as to form a protrusion 322 on the end of the flat tray 31. The protrusion 322 is pivotably engaged with the recess 14 in the body 10 so as to be connected with a motor unit 40. A first cone-shaped gear 321 is connected to the rod 32 and a second cone-shaped gear 33 is engaged with the first cone-shaped gear 321. The second cone-shaped gear 33 includes an axle 331 which is connected with a connection socket 341 of a grid 34. Therefore, when the rod 32 is rotated by the motor unit 40, the first cone-shaped gear 321 rotates the second cone-shaped gear 33 so that the grid 34 is rotated.

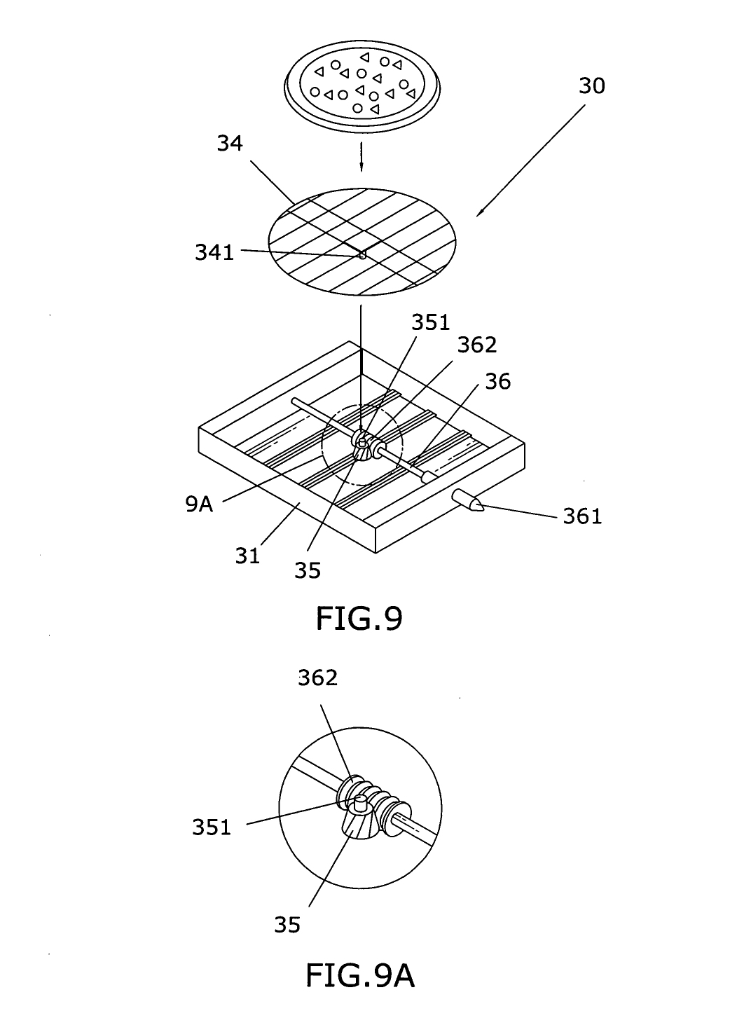

FIGS. 9 and 9A show another embodiment of the tray unit 30 which includes a flat tray 31 and a rod 36 extends through an end of the flat tray 31 so as to form a protrusion 361 on the end of the flat tray 31. The protrusion 361 is pivotably engaged with a recess 14 in the body 10 so as to be connected with a motor unit 40. A worm rod 362 is connected to the rod 36 and a worm gear 35 is engaged with the worm rod 362. The first cone-shaped gear 321 includes an axle 351 which is connected with a connection socket 341 of a grid 34.

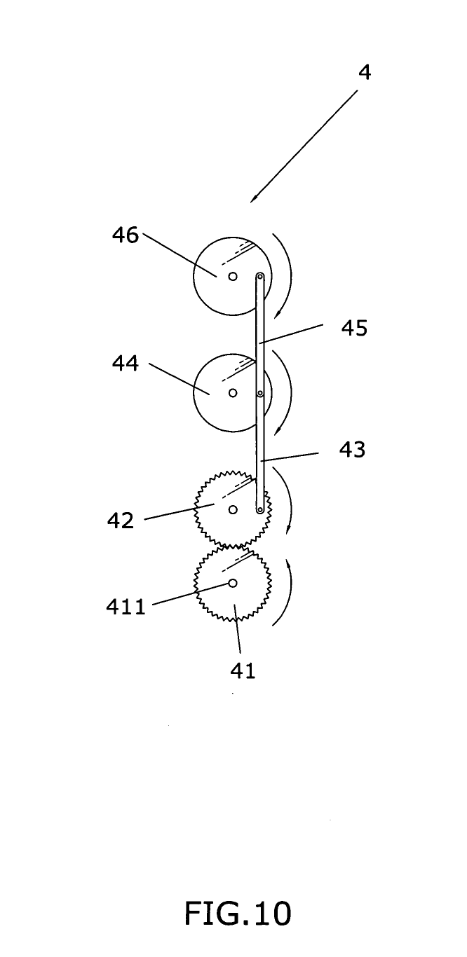

FIG. 10 shows that the motor unit 40 includes a gear set 4 which includes a first gear 41 which has a central hole 411 with which the protrusion 322 is engaged. A second gear 42 is engaged with the first gear 41. A first link 43 has one end connected to the second gear 42 and the other end of the first link 43 is pivotably connected to a first roller 44. A second link 45 has one end connected to the first roller 44 and the other end of the second link 45 is pivotably connected to a second roller 46. The first and second rollers 44, 46 can be cooperated with parts such as a grid or the like so that the food to be cooked can be moved in the body 10 of the oven.

While we have shown and described the embodiment in accordance with the present invention, it should be clear to those skilled in the art that further embodiments may be made without departing from the scope of the present invention.

What is claimed is:

1. An oven comprising:
a body with a door pivotably connected to a front end thereof and a control panel connected to the front end of the body, two support rails located on two opposite insides of the body, and
a movable element unit located in the body and a tray unit positioned in the body.

2. The oven as claimed in claim 1, wherein the element unit includes an element and a first end of a connection rod is connected to the element, a connection end is connected to a second end of the connection rod and an operation handle is connected to the connection end, the operation handle is located outside of the body, one of the two insides of the body has a slot and a part of the connection rod is movably engaged with the slot.

3. The oven as claimed in claim 2, the slot is a curved slot.

4. The oven as claimed in claim 1, wherein the element unit includes an element and a first end of a connection rod is connected to the element, a lever is connected to a second end of the connection rod and located outside of the body, one of the two insides of the body has a slot defined therethrough and the lever movably extends through the slot.

5. The oven as claimed in claim 4, the slot is a curved slot.

6. The oven as claimed in claim 1, wherein the element is connected with a motor which is controlled by a control button on the control panel, the motor is activated by pushing the control button and the element moves in the body.

7. The oven as claimed in claim 1, wherein the element unit includes a knob on outside of the body, a gear located in the body and connected with the knob, a rack engaged with the gear, a positioning member is connected with the element and fixed to the rack, the element is movably engaged with a slot defined in the body.

8. The oven as claimed in claim 1, wherein the tray unit includes a flat tray and a rod extends through an end of the flat tray so as to form a protrusion on the end of the flat tray, the protrusion is pivotably engaged with a recess in the body so as to be connected with a motor unit, a first cone-shaped gear is connected to the rod and a second cone-shaped gear is engaged with the first cone-shaped gear, the second cone-shaped gear includes an axle which is connected with a connection socket of a grid.

9. The oven as claimed in claim 1, wherein the tray unit includes a flat tray and a rod extends through an end of the flat tray so as to form a protrusion on the end of the flat tray, the protrusion is pivotably engaged with a recess in the body so as to be connected with a motor unit, a worm rod is connected to the rod and a worm gear is engaged with the worm rod, the first cone-shaped gear includes an axle which is connected with a connection socket of a grid.

10. The oven as claimed in claim 8, wherein the motor unit includes a gear set 4 which includes a first gear which has a central hole with which the protrusion is engaged, a second gear is engaged with the first gear, a first link has one end connected to the second gear and the other end of the first link is pivotably connected to a first roller, a second link has one end connected to the first roller and the other end of the second link is pivotably connected to a second roller.
